(19) United States
(12) Patent Application Publication
(10) Pub. No.: US 2025/0045547 A1
(43) Pub. Date: Feb. 6, 2025

(54) Identification Method and System for Unmanned Aerial Vehicle

(71) Applicant: chuan ZHONG, BeiJing (CN)

(72) Inventor: chuan ZHONG, BeiJing (CN)

(21) Appl. No.: 18/574,807

(22) PCT Filed: Jun. 6, 2022
(86) PCT No.: PCT/CN2022/000094

§ 371 Date: Dec. 28, 2023

(30) Foreign Application Priority Data
Jul. 1, 2021 (CN) 202110742079.5

(51) Int. Cl. G06K 7/14

(52) U.S. Cl. CPC G06K 7/1417; G06K 7/1413

(57) ABSTRACT

Provided are an identification method and system for an unmanned aerial vehicle. The invention relates to the field of unmanned aerial vehicles and the field of safety management, and in particular to a method and system for identifying the identity of an unmanned aerial vehicle (UAV) by using a specific marker of the UAV.

As the number of UAVs increases, UAVs have become the main users of low-altitude airspace in China after traditional general aircrafts. However, due to its “low, slow, and small” characteristics, the surveillance of UAV flights has become a major problem in low-altitude airspace surveillance.

When there are illegal UAVs (or also compliant UAVs at the same time) in a surveillance area, the identities of the UAVs need to be identified to achieve reasonable control.

In the present invention, by adding a specific marker carrying set information to the surface of the UAV, in the actual operating environment, an observation terminal can obtain the identity information of the UAV by identifying the information of the specific marker (either directly or through query and comparison of preset information), which is helpful for the aerial operation management of the UAV.

### BACKGROUND OF THE PRESENT INVENTION

The present invention relates to the field of unmanned aerial vehicles, and in particular to a method and system for identifying the identity of an unmanned aerial vehicle by using a specific marker of the unmanned aerial vehicle.

### DESCRIPTION OF RELATED ARTS

The unmanned aerial vehicles, referred to as “UAVs”, are unmanned aircraft controlled by a radio remote control device and its own program control device. The UAV is actually a general term for unmanned aircrafts.

Unmanned aircraft systems, also known as “UAS”, refer to systems consisting of a UAV, associated remote control stations, required instruction and control data links, and any other components specified in the approved type design. To put it simply, it is an airplane plus a remote control device.

The market and application of UAVs are currently booming. It is estimated that by 2025, the output value of UAVs reaches 180 billion yuan, maintaining an average annual growth rate of 25% or above.

In recent years, with the rapid development of UAV technology, the UAV industry has flourished. Because UAVs have the characteristics of low cost, no risk of casualties, strong survivability, good maneuverability, and ease of use, more and more industrial applications are emerging. For example, UAVs have been widely used in aerial photography, agricultural and forestry plant protection, power inspection and other fields to replace traditional general aircrafts for related operations. As the number of UAVs increases and their popularity gradually increases, UAVs have become the main users of low-altitude airspace in China after traditional general aircrafts. However, due to its “low, slow, and small” characteristics (low-altitude, slow-speed small aircraft), it is difficult to be detected by radar. The surveillance of UAV flights has become a major problem in low-altitude airspace surveillance.

For flight control of UAVs, no-fly/restricted-fly zones are often set up in some sensitive areas or areas where large crowds gather.

A no-fly zone is an area where UAVs are prohibited from flying. UAVs are not allowed to take off within this area, nor are they allowed to fly into the no-fly zone from other areas.

The restricted-fly zone has certain restrictions on the flying height and speed of UAVs. UAVs flying in this area must comply with the corresponding restrictions.

When a UAV is found flying illegally in a restricted area, existing UAV jammer products can disrupt the GPS navigation system by suppressing the communication between the UAV and the remote control, forcing the UAV to hover and land automatically or driving the UAV away to ensure the safety of low-altitude airspace.

However, when there is also a legally flying UAV in the area, the identity of the UAV needs to be identified to determine whether the flight behavior complies with regulations, thereby achieving reasonable control.

In the Measures for the Management of Civilian UAV Production and Mamifacturing (Draft for Comments) issued by the Ministry of Industry and Information Technology, the content regarding UAV identification is as follows:

Article 6: Civilian UAVs should have unique product identification codes. The Ministry of Industry and Information Technology has formulated standards and regulations related to unique product identification codes for civilian UAVs.

Manufacturing enterprises should prepare and use identification codes on civilian UAVs in accordance with relevant standards and regulations.

Manufacturing enterprises should write the identification codes for civilian UAVs into the non-erasable chip storage areas of UAVs and mark them on the body and outer packaging.

Article 8: Micro-UAVs should be able to automatically broadcast their product identification codes and flight status information during flight through WiFi, Bluetooth, etc., so that they can be easily discovered and identified by other devices during flight.

However, in an actual application, when the practical environment of a UAV is in the air, there is a practical problem that the product identification code of the UAV is difficult to identify:

For example, since the identification code of some models of UAVs is located in the battery compartment of the fuselage/gimbal axis, communication methods such as WIFI/Bluetooth are prone to interference and require a connection process, making them difficult to be discovered and identified by other devices. When multiple UAVs coexist, signal ownership is unclear and confusion can easily occur.

### SUMMARY OF THE PRESENT INVENTION

The present invention provides a method and system for identifying the identity of an unmanned aerial vehicle (UAV) by using a specific marker of the UAV.

To fulfill the above-mentioned purpose, the technical solution of the present invention is implemented as follows.

The present invention discloses a system for identifying the identity of an unmanned aerial vehicle (UAV) by using a specific marker of the UAV. As shown in FIG. 1, the system includes:
a UAV (including a specific marker), a specific marker reader, a UAV information database, and a communication system (optional);
Module 101, the UAV (including a specific marker),
having a specific marker on the surface of the UAV, such as:
1. characters/information barcodes/QR codes/colors and other information patterns, fixedly corresponding to UAV information;
2. lights that can be selected through on-off/color, etc., wherein coded information corresponds to the UAV information;
a combination of the position and number of the patterns and lights on the UAV, which can take into consideration the fuselage characteristics of the UAV to comprehensively correspond to UAV information;
Module 102, the specific marker reader,
corresponding to the specific marker of Module 101, such as:
1. characters/information barcodes/QR codes/colors and other patterns, wherein information acquisition is performed through an optical device, or pictures are obtained by photographing and other means for identification;
2. lights, wherein corresponding information is decoded through on-off/color sampling;
multiple pieces of read information can be combined into an information set.
Module 103, the UAV information database,
wherein data items include information on characteristic markers and corresponding UAV information (UAV identification code/owner identity information/contact information, etc.);
the information read by the module 102 is compared with specific marker information in the data items to confirm the UAV identification code and obtain the owner identity information;
the information on the characteristic markers may also directly correspond to the owner identity information (such as a phone number), which can be read for use, thus simplifying the query; and
Module 104, the communication system, configured to
provide an air communication link between the modules 101 and 103 and capable of dynamically changing the display mode of the specific marker by information exchange, for example, by
instructing the lights on the UAV of a certain UAV identification code to temporarily change to always red to facilitate quick search and positioning.

The present invention further discloses a method for identifying the identity of an unmanned aerial vehicle (UAV) by using a specific marker of the UAV. As shown in FIG. 2, the method includes:
step 201, setting a specific marker for the UAV according to preset information, or in a case where the UAV has a communication link and the specific marker has the ability to change, setting the specific marker according to a dynamic instruction;
wherein the specific marker includes:
1. characters/information barcodes/QR codes/colors and other information patterns, fixedly corresponding to UAV information;
2. lights that can be selected through on-off/color, etc., wherein coded information corresponds to the UAV information; and
3. a combination of the position and number of the patterns and lights on the UAV, which can take into consideration the fuselage characteristics of the UAV to comprehensively correspond to UAV information;
in the case where the UAV has a communication link, dynamically changing the display mode of the specific marker by information exchange; and
step 202, detecting the specific marker by a corresponding detector, and sending the detection information to a UAV information database for comparison and retrieval of relevant information;
for the characters/information barcodes/QR codes/colors and other patterns, performing information acquisition through an optical device, or obtaining pictures by photographing and other means for identification; for the lights, decoding corresponding information through on-off/color sampling; and comparing the identified specific marker information (or information combination) with the information in the UAV information database to determine the UAV information.

The specific marker information may also directly correspond to the owner identity information (such as a phone number), which can be read for use, thus simplifying the query.

In the present invention, by adding a specific marker carrying set information to the surface of the UAV, in the actual operating environment, an observation terminal can obtain the identity information of the UAV by identifying the information of the specific marker (either directly or through query and comparison of preset information), which is helpful for the aerial operation management of the UAV.

### BRIEF DESCRIPTION OF THE DRAWINGS

FIG. 1 is a structural diagram of a system according to the present invention;

FIG. 2 is a flow chart of a method according to the present invention;

FIG. 3 illustrates an embodiment of a fixed-wing UAV using a paint pattern characteristic marker according to the present invention; and

FIG. 4 illustrates an embodiment of a multi-color multi-light characteristic marker for a multi-rotor UAV according to the present invention.

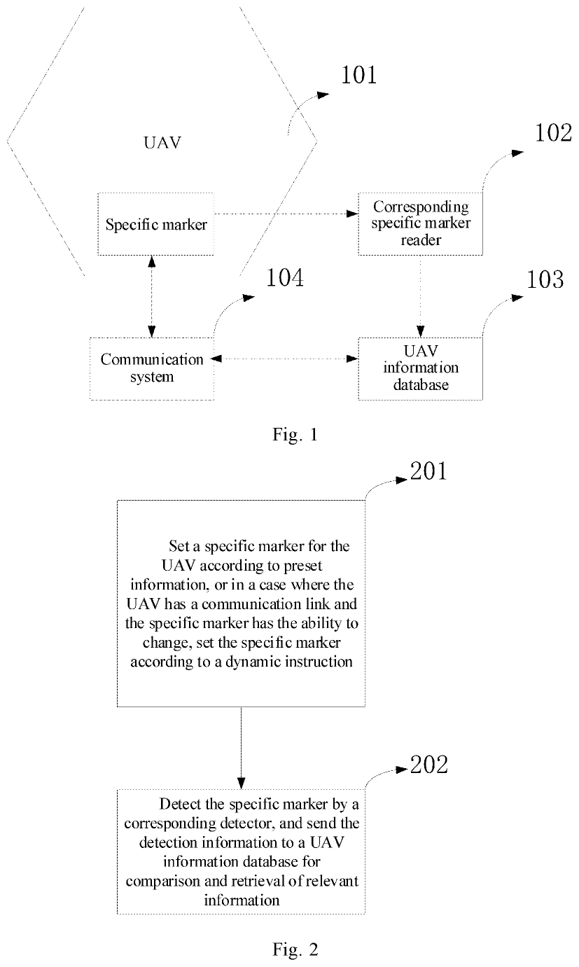

### DETAILED DESCRIPTION OF THE PREFERRED EMBODIMENT

In order to make the objects, technical solutions and advantages of the present invention more clear, the present invention will be described in further detail below with reference to the accompanying drawings and specific embodiments.

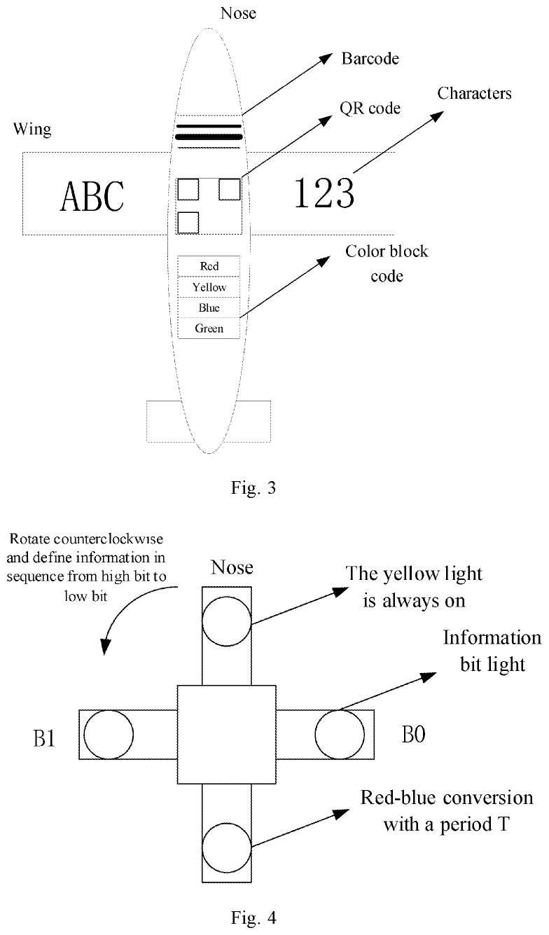

FIG. 3 illustrates Embodiment 1 of a fixed-wing UAV using a paint pattern characteristic marker according to the present invention. As shown in FIG. 3,

From the nose direction to the tail direction, there are barcodes, QR codes, and color block codes on the fuselage (different colors represent different information), and there are characters on the wings. These fixed paintings can be used individually or in combination as the information on characteristic markers, which corresponds to UAV information (pre-registration information such as UAV unique code and owner contact information) in the UAV information database. To facilitate multi-angle observation, characteristic markers can be set up at multiple angles above and below the fuselage.

A camera device can take images of illegal UAVs in the air, obtain the images of the markers, and then identify the corresponding information (for example, scan and identify barcodes/QR codes), and transmit the information to the UAV information database for comparison. If the UAV information is found, the owner is notified promptly.

For some characteristic markers, such as characters/color blocks, manual recognition can be applied. For example, if it is observed by a telescope that a wing code is “ABC123” and the sequence of color blocks on the underbelly is “red, yellow, blue, green”, observers can use these two sets of characteristic marker information to conduct corresponding searches.

The UAV can display corresponding information patterns on the display screen on the surface of the fuselage to achieve a similar effect to painting, and can dynamically change and display more information patterns to carry more UAV information.

Since pattern characteristic markers are easily affected by factors such as fuselage size and weather, and a large number of UAVs are equipped with lights, light characteristic markers can be used to convey characteristic marker information by means of on-off/color, which is more conducive to observation to obtain relevant information. In this case, the information on the light characteristic markers includes information such as on-off/color/quantity/position and combinations thereof and corresponds to the UAV identity information in the database. Appearance characteristics that can distinguish UAV types (such as the number of rotors of a multi-rotor UAV) can be used to assist in the identification and query of UAVs.

For the convenience of description, the present invention uses light in visible light frequency bands that can be recognized by the human eye for description. In the actual environment, other electromagnetic wave frequency bands (such as infrared rays/millimeter waves, etc.) can be applied in the same way as long as corresponding observation devices (such as infrared ray viewers/millimeter wave detectors, etc.) are equipped.

Provided is Embodiment 2 taking a single-color single-light mode for conveying signals by lighting on or off, with a light signal period of 1 s, in which lighting on represents bit 1, and lighting off represents bit 0.

TABLE 1

| S0 | S1 | S2 | S3 | S4 | S5 |
|---|---|---|---|---|---|
| B0 | B1 | B2 | B3 | B4 | B5 |
| B6 | B7 | B8 | B9 | B10 | B11 |
| B12 | B13 | B14 | B15 | B16 | B17 |
| B18 | B19 | B20 | B21 | B22 | B23 |

As shown in Table 1, it is an example of a 30-second information transmission period, in which S0-S5 are 6-bit synchronization bits, used for information field division, and B0-B23 are 24-bit information bits. It is required to avoid the occurrence of the same bit sequence as the synchronization bits. The information bits sent by the light correspond to the UAV information (UAV unique code/owner identity information, etc.) in the UAV information database.

The optical camera device takes images of a UAV and samples the light in a 1-second period, and the bit sequence is obtained by determining whether the light is on or off. After the synchronization bit sequence is found in the obtained bit sequence, the subsequent information bits and other possible information (such as aircraft model) are used to compare with the data items in the UAV information database to obtain the UAV unique code and other related information such as owner information.

With prior agreement, the UAV can also use other methods of light change to send other pre-defined coded information (for example, sending “SOS” in Morse code indicates that the UAV is in a certain disabled state).

The UAV may be equipped with multiple lights, and each light may be multi-colored (equivalent to changes in radio wave frequency), which can provide more capabilities for tracking and communication of the UAV.

Provided is Embodiment 3 in which two red and blue dual-color lights (A/B) convey information by virtue of colors,

Light A performs red-blue conversion with a period T. Bit information 0 is conveyed if light B and light A are in the same color, and bit information 1 is conveyed if light B and light A are in different colors. Similarly, information in Table 1 is conveyed. Since the lights are always on, it is conducive to UAV tracking. T may have multiple values (corresponding to different information rates). An observation receiving terminal may determine the value of T according to the color change time of light A, and observe, in each period T, whether light B has the same color as light A to determine the information bits sent.

FIG. 4 illustrates Embodiment 4 of a multi-color multi-light characteristic marker for a multi-rotor UAV according to the present invention. As shown in FIG. 4,
assume that each of the four symmetrical cantilevers of the UAV has a light (which can emit red, yellow and blue colors), and in this case, there can be multiple information bits in each period T, but it is required to determine the high and low bits of the information bits. Let one cantilever light be yellow and always on to represent the nose of the UAV, and the opposite cantilever light should be red and blue and change in period T to represent the tail. The remaining cantilever lights are rotated counterclockwise in the aerial view direction and defined in sequence from high bit to low bit. If they have the same color as the light at the tail, bit information 0 is conveyed. If they have different colors from the light at the tail, bit information 1 is conveyed. In this way, two pieces of bits information can be sent in each period T. The observation receiving terminal determines the spatial direction of the UAV through the light characteristics of the nose and tail, and observes the remaining two lights in each period T to determine the information bits sent.

Provided is Embodiment 5 of changing the light signal under instructions in the case where the UAV has a communication link with the communication system.

In the case of a large number of UAVs, considering that corresponding specific light marker codes generated corresponding to the UAV unique codes may have a long code word (generated by multi-steps such as channel coding/encryption coding) and require a long time to observe, in a local environment, the UAVs change light signals under the instructions of the communication system (the characteristic marker information can be dynamically set), which may help to quickly identify and distinguish the UAVs.

For example, if a UAV is found in a restricted zone (assuming that the positioning system fails and cannot be corrected on its own), and the communication system near the zone has flight records of 9 UAVs, the ground control center sends instructions to the nine UAVs through the communication system. The characteristic marker lights are set in different light modes (1/2/3/4 lights, red/yellow/blue, always on/flashing), and it is found that the lights of the UAV are changed to one of the modes (for example, 3 lights/red/always on), the identity of the illegal UAV can be quickly determined, the UAV information can be obtained from the database, and then subsequent processing can be carried out.

Specific marker information may also be directly sent plain-code information of the owner, such as the painted mobile phone number of the owner, thus simplifying the operation of database query.

Provided is Embodiment 6 of directly obtaining the mobile phone number information of the owner by turning on and off the lights of a UAV.

In a round of light mode, lights are on for 0.5 second and off for 0.5 second.

In a period of 15*12=180 seconds, the lights are always on for the first 15 seconds to distinguish the starting digit of the mobile phone number. In each remaining 15-second period, the lights are held off for 5 seconds for the counting interval, and within 10 seconds, the lights are on 1 to 10 times, corresponding to the numbers 0 to 9 in sequence.

In this way, by observing the number of times the lights are on within each 15 second in a 180-second period, the information of an 11-digit phone number can be obtained.

This example should be regarded as a simplified example of the method of the present invention. In this case, the interpreted information can be regarded as directly corresponding to the owner information associated with the data items, thereby simplifying the query.

The present invention takes a UAV as the main description object, but it can be applied to other aerial flying objects in the same way, such as airships/model aircrafts.

The embodiments mentioned above are merely preferred embodiments of the invention and not intended to limit the invention. Any of modifications, equivalent substitutions, improvements, etc. made within the spirit and principle of the invention shall be covered in the protection scope of the invention.

What is claimed is:

1. A system for identifying the identity of an unmanned aerial vehicle (UAV) by using a specific marker of the UAV, the system comprising:
a UAV (comprising a specific marker), a specific marker reader, a UAV information database, and a communication system (optional);
Module 101, the UAV (comprising a specific marker),
having a specific marker on the surface of the UAV, such as:
1. characters/information barcodes/QR codes/colors and other information patterns, fixedly corresponding to UAV information;
2. lights that can be selected through on-off/color, etc., wherein coded information corresponds to the UAV information;
a combination of the position and number of the patterns and lights on the UAV, which can take into consideration the fuselage characteristics of the UAV to comprehensively correspond to UAV information;
Module 102, the specific marker reader,
corresponding to the specific marker of Module 101, such as:
1. characters/information barcodes/QR codes/colors and other patterns, wherein information acquisition is performed through an optical device, or pictures are obtained by photographing and other means for identification;
2. lights, wherein corresponding information is decoded through on-off/color sampling;
multiple pieces of read information can be combined into an information set;
Module 103, the UAV information database,
wherein data items comprise information on characteristic markers and corresponding UAV information;
the information read by the module 102 is compared with specific marker information in the data items to confirm the UAV identification code and obtain the owner identity information; and
Module 104, the communication system, configured to
provide an air communication link between Modules 101 and 103 and capable of dynamically changing the display mode of the specific marker by information exchange.

2. The specific marker according claim 1, comprising characters/information barcodes/QR codes/lights/colors and other information carrying methods or a combination thereof, wherein an observation terminal can obtain the carried information about the UAV through corresponding detection methods.

3. The specific marker according to claim 1, the specific marker carrying the identity information of the UAV (directly or indirectly associated with UAV unique identification code/owner identity information/contact information, and the like).

4. The specific marker according to claim 1, wherein if having the ability to dynamically change the display mode, the specific marker can change multiple display patterns to carry the UAV information.

5. The specific marker according to claim 1, wherein if the specific marker has the ability to dynamically change the display mode and the UAV has a communication link with the communication system, the corresponding display mode can be changed according to instructions.

6. The specific marker according to claim 1, wherein the specific marker is located on the fuselage surface of the UAV to achieve the effect of being observed by a corresponding observation device when the UAV is flying in the air.

7. The specific marker according to claim 1, wherein, through different display function definitions, in addition to conveying the identity data information of the UAV, the characteristic marker can also be used to convey other predefined information, comprising fuselage orientation information/multi-bit data information/clock information.

8. A method for identifying the identity of an unmanned aerial vehicle (UAV) by using a specific marker of the UAV, the method comprising:
step 201, setting a specific marker for the UAV according to preset information, or in a case where the UAV has a communication link and the specific marker has the ability to change, setting the specific marker dynamically;
wherein the specific marker includes:
1. characters/information barcodes/QR codes/colors and other information patterns, fixedly corresponding to UAV information;
2. lights that can be selected through on-off/color, etc., wherein coded information corresponds to the UAV information; and
3. a combination of the position and number of the patterns and lights on the UAV, which can take into consideration the fuselage characteristics of the UAV to comprehensively correspond to UAV information;
in the case where the UAV has a communication link, dynamically changing the display mode of the specific marker by information exchange; and
step 202, detecting the specific marker by a corresponding detector, and sending the detection information to a UAV information database for comparison and retrieval of relevant information;
for the characters/information barcodes/QR codes/colors and other patterns, performing information acquisition through an optical device, or obtaining pictures by photographing and other means for identification; for the lights, decoding corresponding information through on-off/color sampling; and comparing the identified specific marker information (or an information combination) with the information in the UAV information database to determine the UAV information;
the specific marker information can also directly correspond to the owner identity information (such as a phone number), which can be read for use, thus simplifying the query.
